(19) United States
(12) Patent Application Publication
(10) Pub. No.: US 2007/0247757 A1
(43) Pub. Date: Oct. 25, 2007

(54) Customizable Cartridge for Protecting a Readable and/or Writable Data Storage Medium

(75) Inventors: Waltherus Cornelis Jozef Bierhoff, Eindhoven (NL); Dido Van Klinken, Eindhoven (NL); Davy Maria Wilibrordus Schaeken, Eindhoven (NL); Astrid Andreassen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,442

(22) PCT Filed: Jun. 9, 2005
(86) PCT No.: PCT/IB05/51891

§ 371 Date: Dec. 12, 2006

(30) Foreign Application Priority Data
Jun. 17, 2004 (EP) 04102765.7

(51) Int. Cl. G11B 23/03

(52) U.S. Cl. 360/133

(57) ABSTRACT

The invention relates to a cartridge for protecting a readable and/or writable data storage medium, such as an optical disk. The cartridge comprises a first cartridge part (1) for containing the data storage medium and a second cartridge part (2) connected to the first cartridge part and projecting therefrom. The second cartridge part is customized so as to perform at least one secondary function of the cartridge, such as connecting the cartridge to another object, or an electronic function such as data or copy protection.

The invention relates to a cartridge for protecting a readable and/or writable data storage medium.

In the prior art, several embodiments of cartridges are known to accommodate a disc, hereinafter spelled disk, such as a magnetic or optical disk. In this context, reference is made to U.S. Pat. No. 6,014,365. A cartridge has the function of protecting a disk from dust, scratches, fingerprints etc. and to allow a mechanical interface of the disk to be engaged by a drive member in a disk drive unit. As the cartridge has a function mainly dictated by technical functionalities, the known cartridges have a technical design and do not offer any additional functionality.

It is an object of the invention to provide a cartridge which is designed to meet technical criteria, on the one hand, and offers more possibilities for design and/or additional functionalities, on the other hand.

This object is achieved by the cartridge according to the invention, which has the primary function of protecting a readable and/or writable data storage medium and comprises a first cartridge part for containing the data storage medium and a second cartridge part connected to the first cartridge part and projecting therefrom, said second cartridge part being customized so as to perform at least one secondary function.

By dividing the cartridge into more parts, one part may be designed in accordance with the technical specifications dictated by the data storage medium, and another part may be designed to create additional functionalities and/or an appealing design. The second part of the cartridge thereby gives freedom to customize the cartridge design.

The cartridge preferably has the features of claim 2. In this embodiment, it is not necessary to detach the second cartridge part before the cartridge is used in an electronic device, for example, a disk drive unit in the case of a disk-containing cartridge. When the cartridge is completely inserted into an electronic device in order to use the data storage medium, the interior space of the disk drive unit should be adapted to the total shape and dimensions of the cartridge. In this case, the shape and dimensions of the complete cartridge should be maintained within standard limits in order to allow unhindered use of the cartridge. In other cases, it is possible that at least a part of the cartridge remains outside the device during use of the data storage medium, which would reduce the requirements imposed on the dimensions and/or shape of at least the second part of the cartridge.

A preferred embodiment of the cartridge is defined in claim 3. This connection means may be, for example, an electronic or mechanical connection. In the first-mentioned case, the second cartridge part has a secondary function of forming an interface with one or more other devices. In such an embodiment, the second cartridge part may comprise, for example, electronics in order to create an electronic disk data protection. Such a protection may consist of a copy protection or a protection against unauthorized use of data on the data storage medium. In this data protection embodiment, it is the contents producer who may customize the second cartridge part.

In this case, the embodiment of claim 6 is preferred, thereby preventing customers from tampering with the cartridge protection.

If the connection means is a mechanical connection, it may be used to connect the cartridge to another object, such as a piece of clothing, a hanger or pendant or the like.

This embodiment may be used to create wearable electronics and to allow customers to customize a cartridge and even create a piece of jewellery.

Particularly, but not exclusively, the features of claim 8 are preferred in this embodiment. Customers may select their own customized second cartridge part in order to combine it with the first cartridge part and even create a collection of second cartridge parts in order to use, store or wear the same cartridge in different ways.

Another embodiment of the invention is defined in claim 10.

The invention also relates to an electronic device for use with such a disk cartridge, in which case the electronic device may have the features of claim 15.

Furthermore, the invention relates to a cartridge according to the invention, provided with a data storage medium. The characteristic features of the second cartridge part may be used, for example, to make the type of contents on the data storage medium in the cartridge recognizable, for example, to distinguish between video, audio, images, data, games, etc. The characteristic features of the second cartridge part may also be formed by a content description.

Although the invention is not limited thereto, the data storage medium is preferably a rotatable disk, such as an optical disk. Moreover, the invention relates to a second cartridge part as defined in claim 11.

Further details and advantages of the invention are apparent from a description of preferred embodiments with reference to the drawings illustrating the invention in a very schematic way.

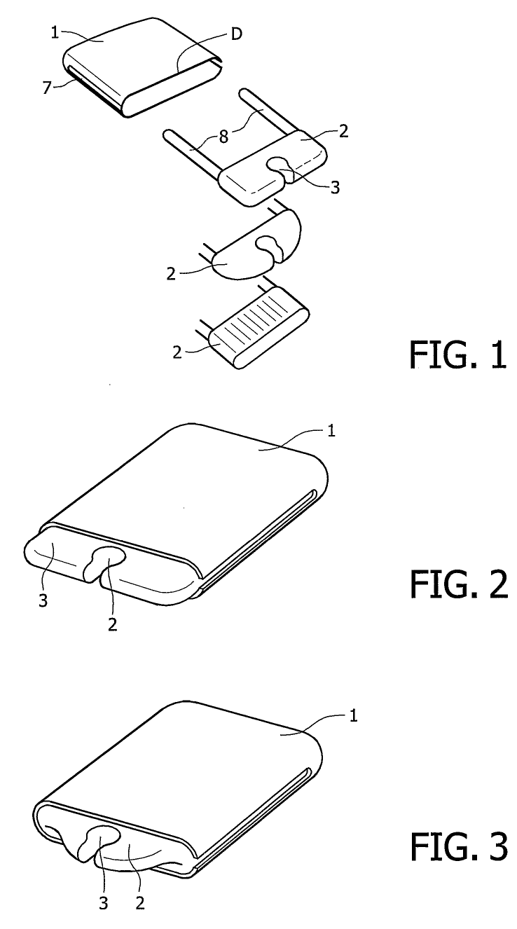

FIG. 1 is a schematic perspective view of a cartridge assembly showing one first cartridge part and three exchangeable second cartridge parts.

FIG. 2 is a perspective view of an assembled cartridge containing the first cartridge part and one of the second cartridge parts of FIG. 1.

FIG. 3 is a perspective view of another cartridge containing the first cartridge part and another second cartridge part.

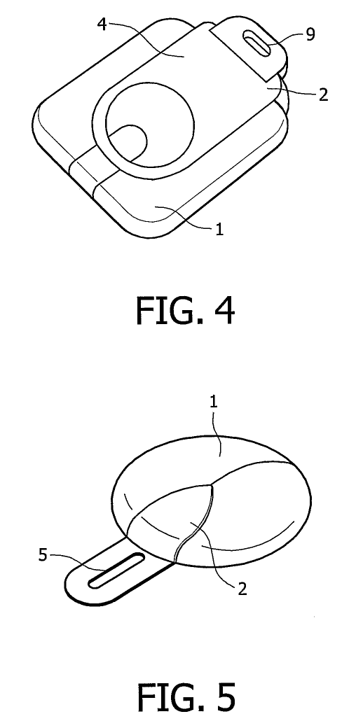

FIG. 4 is a perspective view of another embodiment of the cartridge according to the invention.

FIG. 5 is a perspective view of a part of another embodiment of the first cartridge part and a second cartridge part.

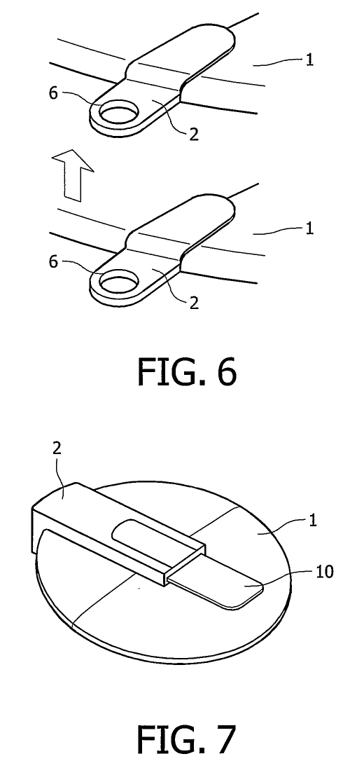

FIG. 6 is a perspective view of a part of two stacked cartridges, which may be connected to each other by means of the second cartridge part.

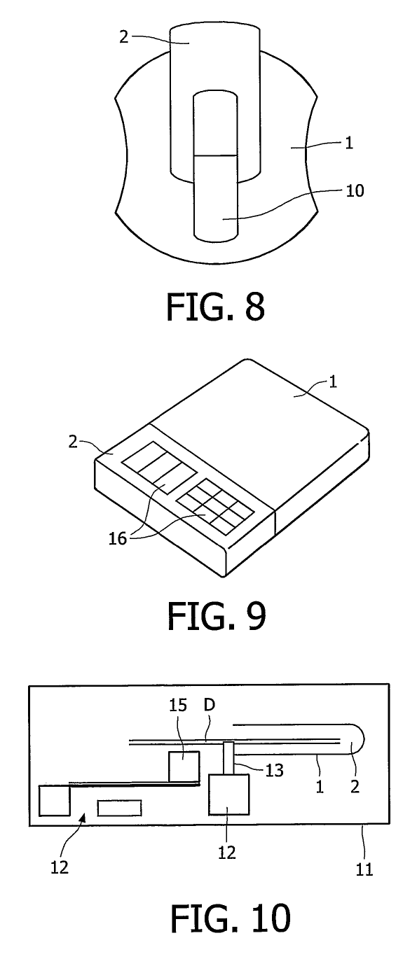

FIGS. 7 and 8 are a perspective view and a plan view, respectively, of further embodiments of the cartridge according to the invention.

FIG. 9 is a perspective view of another embodiment of the cartridge according to the invention.

FIG. 10 is a very schematic cross-sectional view of an electronic device for use with a cartridge according to the invention.

FIG. 1 shows very schematically a cartridge containing a readable and/or writable data storage medium, in this case a small optical disk D having a diameter of, for example, 20 to 40 mm. This cartridge, which may be made mainly of plastic, protects the disk accommodated therein against environmental influences, such as dust, scratches, fingerprints and the like. The disk D is rotatably accommodated in the cartridge and, in the case of an optical disk, the cartridge will generally have a closed position in which it fully encloses the disk, and an open position in which at least a part of the disk is exposed in order to be read and/or written by an optical pickup unit of a disk drive (FIG. 8). The general structure and layout of a cartridge is known in the art and will not be further elucidated here.

According to the invention, the cartridge comprises at least a first cartridge part 1 containing the disk (not shown) and a second cartridge part 2 connected to the first cartridge part 1. The second cartridge part 2 has such dimensions and is connected to the first cartridge part in such a way that it projects from the first cartridge part 1. The parts 1 and 2 jointly form the outline of the cartridge.

In the embodiment shown in FIG. 1, the first cartridge part is a flat, substantially square box having one small open side. This side will be closed by the second cartridge part 2 in the connected position of the parts 1 and 2. It is of course also conceivable that the first cartridge part is closed on all sides and the second cartridge part 2 is positioned against one of the outer walls of the first cartridge 1 in the connected position.

As is illustrated in FIG. 1, the first and second parts are releasably connectable so as to be able to exchange second cartridge parts 2. This enables either a consumer or a manufacturer/distributor to customize the cartridge. A manufacturer might wish to customize the cartridge in order to differentiate various types of disks in the cartridge, for example, video disks, music disks, data disks, game disks, and the like. Different shapes or colors indicate the type of disk in the cartridge. The second cartridge part 2 may also be used as a carrier for print describing the contents of the disk.

A customer might wish to customize the cartridge, for example, in view of its mechanical connection function or in view of its appearance. The second cartridge part may be provided with connecting means 3 in order to connect the cartridge to another object, for example, a piece of clothing, a support like a key fob or a storage box, a hanger or pendant or the like. The connecting means of the second cartridge part 2 may also be provided with a clip 4 as shown in FIG. 4 to clip the cartridge to a pocket, a belt or the like. Another variation is shown in FIG. 5 in which the second cartridge part 2 comprises a button hole 5 to connect the cartridge, for example, to the button of a piece of clothing. In the embodiment shown in FIG. 6, the second cartridge part 2 comprises a press stud or press fastener 6, such that two or more cartridges can be connected to each other through the second cartridge part 2.

In FIG. 1, the first cartridge part 1 is provided with first coupling members 7, here in the form of grooves in the small side walls adjacent to the open side of the first cartridge part 1. The second cartridge part 2 comprises two second coupling members 8, here in the form of legs adapted to engage the grooves 7 on the first cartridge part 1 so that the first cartridge part 1 is accommodated between the legs 8 of the second cartridge part 2. Snap means or other locking members may be provided to prevent or hinder removal of the second cartridge part from the first cartridge part 1. The snap means will be provided on the elastic arms 8 and in the grooves 7 on the first cartridge part 1. Many other configurations of the first and second coupling members 7, 8 are of course conceivable. The second cartridge part 2 will preferably be fixedly but releasably mounted onto the first cartridge part 1.

FIGS. 2 and 3 show two embodiments of the cartridge with assembled cartridge parts 1 and 2. The Figures clearly show that the second cartridge part 2 projects from the first cartridge part 1, but in this case only to a limited extent and only co-axially with the first cartridge part and not laterally/vertically beyond the outline or cross-section of the first cartridge part 1. This will make it easy to use the cartridge in a drive unit of an electronic device with the second cartridge part 2 connected to the first cartridge part 1.

FIG. 4 shows an embodiment of the cartridge according to the invention, in which the second cartridge part 2 is provided on the outside of the first cartridge part 1 and projects upwardly beyond the first cartridge part 1 and overlaps this part 1 to a large extent. This second cartridge part 2 is provided with clip 4 with which a flat part may be clamped between the upper side of the first cartridge part 1 and the clip 4 of the second cartridge part 2. In this way, the cartridge may be clipped, for example, on a piece of clothing or the like, such as a belt or a pocket. The second cartridge part 2 also has a portion with an opening 9 through which a hanger, a key fob or the like can be threaded in order to suspend a cartridge, for example, for the purpose of wearing it.

FIG. 5 shows an embodiment of the cartridge, in which the first cartridge part 1 has a circular contour and the second cartridge part 2 forms a lug on the cartridge and has a button hole 5 with which the cartridge may be fastened to a button on a piece of clothing or the like. This second cartridge part 2 may either be formed in such a way that it must be disconnected from the first cartridge part 1 before the cartridge is introduced into a disk drive unit, or such that it can remain connected to the first cartridge part 1 when loading the cartridge into the disk drive unit.

The embodiment of FIG. 6 is provided with a second cartridge part 2 having a lug shape which is similar to that shown in FIG. 5. However, in this embodiment, the second cartridge part 2 has a press fastener 6 which has such a configuration that a press fastener 6 of another cartridge can be connected thereto from either side, so that a stack of cartridges connected to each other can be formed. In this way, a number of cartridges can be stored together.

In the embodiments of FIGS. 7 and 8, the cartridge is adapted in such a way that it can be worn as a decorative item or a piece of jewellery, in this case as a tie-clip. The second cartridge part 2 is fork-shaped and is provided with a clip 10 which is slidable between the legs of the fork-shaped part of the second cartridge 2. It is resiliently bent so as to keep the cartridge attached to a tie or another part.

The first cartridge part 1 has a circular circumference in the embodiment of FIG. 7 and is circular with flattened parts in the embodiment of FIG. 8. If the data storage medium is a disk, it will be relatively smaller in the embodiment of FIG. 8. Other circumferential shapes of the first cartridge part 1 are conceivable.

FIG. 9 shows a further embodiment of the cartridge according to the invention, in which the second cartridge part 2 has a different secondary function. For this secondary function, the second cartridge part 2 is provided with push buttons or other control means in order to operate electronics within the second cartridge part 2. These electronics may have the function of, for example, selective release of data on the disk in the first cartridge part 1. By entering certain codes with the push buttons 16, a part or the whole content of the disk will be released. The code or codes will be provided by the contents provider, generally after payment of a fee. In this embodiment, the second cartridge part 2 should also have an interface, i.e. an electronic connection, to cooperate with a processor in a disk drive unit in order to read selected data from the data disk only.

In this embodiment, there may also be an electronic connection between the first and second cartridge parts 1 and 2. Furthermore, in this embodiment, the second cartridge part 2 will be connected to the first cartridge part 1 so that at least a customer will not be able to disconnect them. The manufacturer of the disk cartridge or the manufacturer of the disk or even a distributor will assemble the first and second cartridge parts 1, 2 and in certain cases might also be able to disconnect them with a special tool or the like.

The electronics in the second cartridge part 2 may also have other secondary functions, such as copy protection (for example, by means of a chip in the second cartridge part) or other electronic functions.

FIG. 10 shows an electronic device, such as a PDA, a mobile phone, a disk player or the like, including a housing 11 and a disk drive unit accommodated therein. This disk drive unit comprises a motor 12 and spindle 13, as well as an optical system 14 including a pickup unit 15 to read/write the data from/onto a disk D. The disk D has its clamping area engaged by the spindle 13 of the motor 12 in order to be driven. In FIG. 8, the disk D is shown as being accommodated in the cartridge with the cartridge part 1 in the open position in which a large part of the disk D is exposed in order to enable the lens of the pickup unit 1 to be positioned very closely to the disk 1. The cartridge is inserted into the disk drive unit with the second cartridge part 2 connected to the first cartridge part 1. The space within the electronic device is sufficient to accommodate both the first and the second cartridge part 1 and 2.

It will be evident from the foregoing that the invention provides a data storage cartridge which offers great possibilities for customization by manufacturers, data producers, distributors and customers alike.

The invention is not limited to the above-described embodiments as shown in the drawings, which can be varied in several ways without departing from the scope of the appended claims. For example, other connecting means of the second cartridge part will be zippers, Velcro®, safety pins and the like.

It is to be noted that use of the indefinite article “a” or “an” preceding an element in the specification and claims does not exclude the presence of a plurality of such elements, and that use of the verb “comprise” and its conjugations does not exclude the presence of elements other than those stated in the claims. Any reference sign placed between parentheses shall not be construed as limiting the claim. It is further to be noted that various characteristic features as defined in the set of claims may occur in combination.

In the preferred embodiments, the disk is an optical data disk. However, the invention may also be used for cartridges containing all types of different disks, such as magnetic or magneto-optical disks, and also other data storage media, such as EEPROM or other memory types.

1. A cartridge having the primary function of protecting a readable and/or writable data storage medium, the cartridge comprising:
a first cartridge part (1) for containing the data storage medium (D) and a second cartridge part (2) connected to the first cartridge part and projecting therefrom, said second cartridge part being customized so as to perform at least one secondary function.

2. A cartridge as claimed in claim 1, wherein the first and second cartridge parts (1, 2) form a unit, in which the first and second cartridge parts are fixed to each other in their connected position and the unit has such a shape that the second cartridge part remains connected to the first cartridge part during use of the cartridge.

3. A cartridge as claimed in claim 1, wherein the secondary function is a connecting function, the second cartridge part being provided with connection means (3).

4. A cartridge as claimed in claim 3, wherein said connection means is an electronic connection, the second cartridge part having a secondary function of forming an interface with one or more other devices.

5. A cartridge as claimed in claim 4, wherein the second cartridge part performs a further secondary function, in particular an electronic disk data protection function and comprises electronics (10) to perform said function.

6. A cartridge as claimed in claim 5, wherein the second cartridge part (2) is fixed to the first cartridge part (1) so that at least the user or users will be prevented from disconnecting the second cartridge part from the first cartridge part.

7. A cartridge as claimed in claim 3, wherein said connection means is a mechanical connection for connecting the cartridge to another object such as a piece of clothing.

8. A cartridge as claimed in claim 1, wherein the second cartridge part is releasably connected to the first cartridge part, the first cartridge part (1) comprising at least a first coupling member (7) and the second cartridge part (2) comprising at least a second coupling member (8) adapted to co-operate with the first coupling member so as to fixedly, but releasably connect the second cartridge part to the first cartridge part.

9. A cartridge as claimed in claim 1, wherein the second cartridge part (2) overlaps the first cartridge part (1) to a large extent.

10. A cartridge as claimed in claim 1, wherein the second cartridge part (2) has a characteristic feature selected from the group of shape, color, and print.

11. A second cartridge part (2) presenting all of its features as claimed in claim 1 and being thus constructed and evidently intended for use in a cartridge as claimed in claim 1.

12. A cartridge as claimed in claim 1, provided with a readable and/or writable data storage medium.

13. A cartridge as claimed in claim 12, wherein the second cartridge part (2) has a characteristic feature of identifying the contents of data on the data storage medium.

14. A cartridge as claimed in claim 12, wherein the data storage medium is a rotatable disk (D), such as an optical disk.

15. An electronic device for use with a cartridge as claimed in claim 12, said device comprising a housing (11) containing a disk drive unit (12 to 15) and a closable space to accommodate a disk cartridge for engagement by the disk drive unit, said space being adapted to accommodate both the first and the second cartridge part (1, 2).
